(19) United States
(12) Patent Application Publication
(10) Pub. No.: US 2017/0142929 A1
(43) Pub. Date: May 25, 2017

(54) Selective Access System For A Feeder

(71) Applicant: Scimetrics Limited Corp., Wellington, CO (US)

(72) Inventor: Richard Poché, Wellington, CO (US)

(73) Assignee: Scimetrics Limited Corp., Wellington, CO (US)

(21) Appl. No.: 14/947,088

(22) Filed: Nov. 20, 2015

(51) Int. Cl. A01K 5/02; A01M 25/00

(52) U.S. Cl. CPC A01K 5/02; A01M 25/002; A01M 2200/00

(57) ABSTRACT

A selective access system for permitting selective access to ingestible matter disposed within a feeder, and methods of making and using such a selective access system, whereby the selective access system includes a cover having opposing cover first and second ends, the cover first end configured to rotatably couple to the feeder to allow the cover to rotate about a rotation axis between a first position and a second position. In the first position, the cover overlays a feeder opening in which the ingestible matter is disposed. In the second position, the cover disposes away from the feeder opening to permit access to the ingestible matter. The selective access system further includes a force generator coupled to the cover, wherein the force generator generates a pre-selected force amount which when unopposed, provides the first position of the cover.

### SUMMARY OF THE INVENTION

A broad object of a particular embodiment of the invention can be to provide a selective access system for permitting selective access to ingestible matter disposed within a feeder, and methods of making and using such a selective access system, whereby the selective access system includes a cover having opposing cover first and second ends, the cover first end configured to rotatably couple to the feeder to allow the cover to rotate about a rotation axis between a first position and a second position. In the first position, the cover overlays a feeder opening in which the ingestible matter is disposed. In the second position, the cover disposes away from the feeder opening to permit access to the ingestible matter. The selective access system further includes a force generator coupled to the cover, wherein the force generator generates a pre-selected force amount which when unopposed, provides the first position of the cover.

Naturally, further objects of the invention are disclosed throughout other areas of the specification, drawings, and claims.

### BRIEF DESCRIPTION OF THE DRAWINGS

FIG. 1 is an illustration of a method of using a particular embodiment of the selective access system coupled to a feeder to permit selective access to ingestible matter disposed within a feeder opening, whereby the ingestible material comprises bait including a toxic agent.

FIG. 2 is a perspective view of the selective access system coupled to a feeder having a pair of covers configured to overlay a feeder opening of the feeder, whereby one of the pair of covers disposes in a first position and the other of the pair of covers disposes in a second position.

FIG. 3 is a front view of the selective access system coupled to a feeder having a pair of covers configured to overlay a feeder opening of the feeder, whereby the covers dispose in a first position.

FIG. 4 is a rear view of the selective access system coupled to a feeder having a pair of covers configured to overlay a feeder opening of the feeder, whereby the covers dispose in a first position.

FIG. 5 is a left side view of the selective access system coupled to a feeder having a pair of covers configured to overlay a feeder opening of the feeder, whereby the covers dispose in a first position.

FIG. 6 is a right side view of the selective access system coupled to a feeder having a pair of covers configured to overlay a feeder opening of the feeder, whereby the covers dispose in a first position.

FIG. 7 is a top view of the selective access system coupled to a feeder having a pair of covers configured to overlay a feeder opening of the feeder, whereby the covers dispose in a first position.

FIG. 8 is a bottom view of the selective access system coupled to a feeder having a pair of covers configured to overlay a feeder opening of the feeder, whereby the covers dispose in a first position.

### DETAILED DESCRIPTION OF THE INVENTION

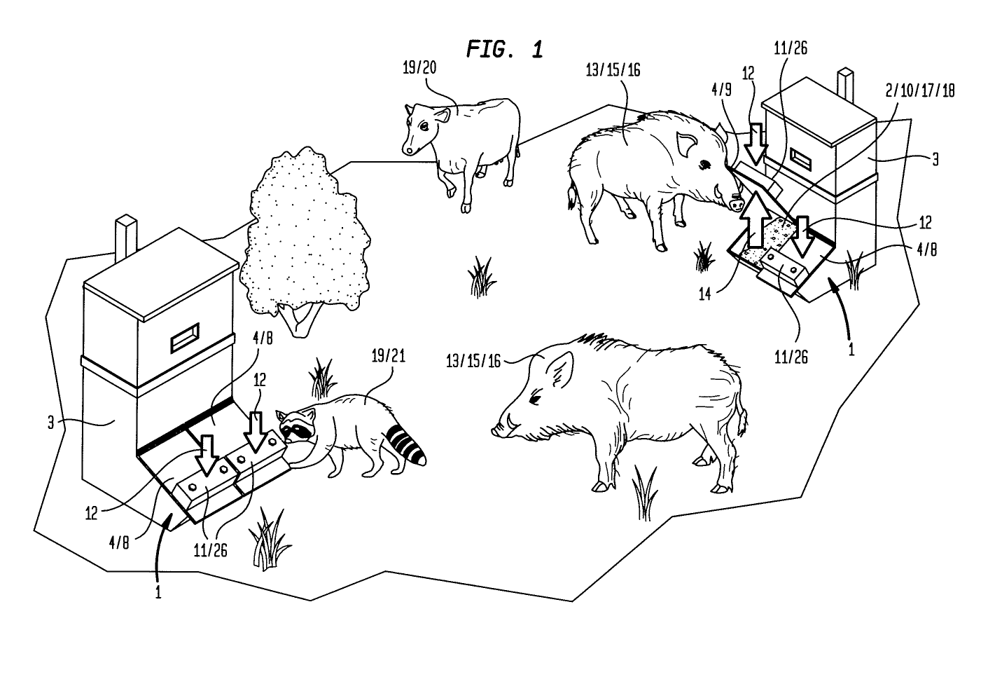

Now referring primarily to FIG. 1, which illustrates a method of using a particular embodiment of a selective access system (1) for permitting selective access to ingestible matter (2) disposed within a feeder (3), whereby the selective access system (1) includes a cover (4) having opposing cover first and second ends (5)(6), the cover first end (5) configured to rotatably couple to the feeder (3) to allow the cover (4) to rotate about a rotation axis (7) between a first position (8) and a second position (9). In the first position (8), the cover (4) overlays a feeder opening (10) in which the ingestible matter (2) is disposed. In the second position (9), the cover (4) disposes away from the feeder opening (10) to permit access to the ingestible matter (2). The selective access system (1) further includes a force generator (11) coupled to the cover (4), whereby the force generator (11) generates a pre-selected force amount (12) which when unopposed, provides the first position (8) of the cover (4). The second position (9) is provided by a counterforce generator (13) which generates a counterforce amount (14) which is greater than the pre-selected force amount (12), thus opposing the pre-selected force amount (12) to dispose the cover (4) away from the feeder opening (10) to permit access to the ingestible matter (2).

Again referring primarily to FIG. 1, the selective access system (1) can be used to facilitate management of one or more targeted animals (15), for example wild boars (16) or feral hogs (16) which can cause agricultural and environmental damage, by permitting selective access to ingestible matter (2) such as bait (17) including a toxic agent (18) while precluding non-targeted animals (19), such as livestock (20) or wildlife (21) other than wild boars (16) or feral hogs (16), from accessing the bait (17) including the toxic agent (18).

For the purposes of the present invention, the term “selective” means of, relating to, or characterized by selection, whereby selection means the act of choosing something from a group.

For the purposes of the present invention, the term “access” means a way of being able to get something.

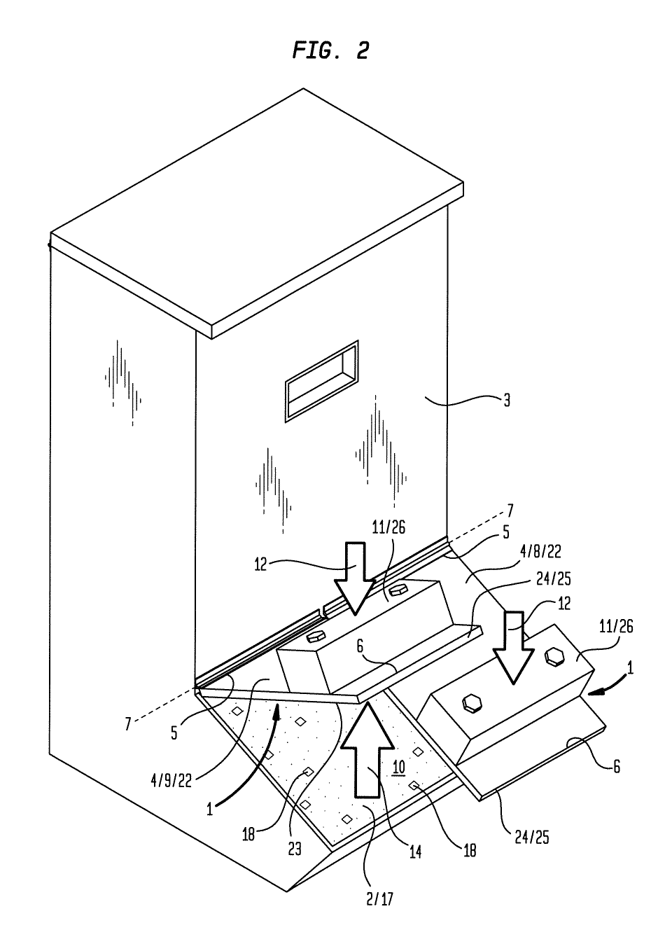

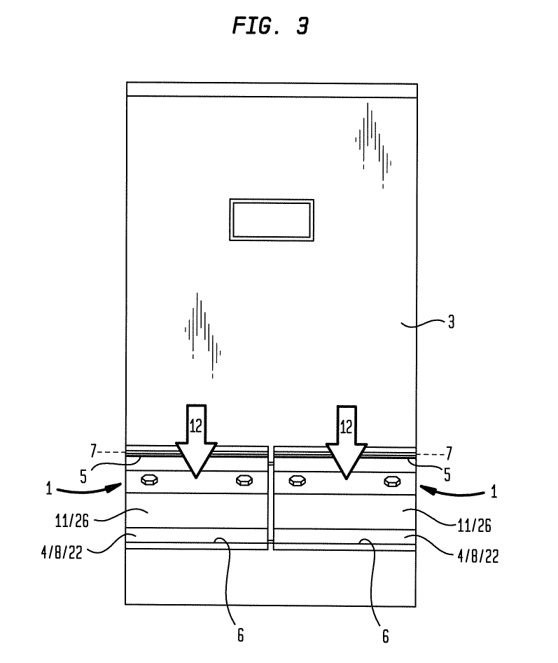

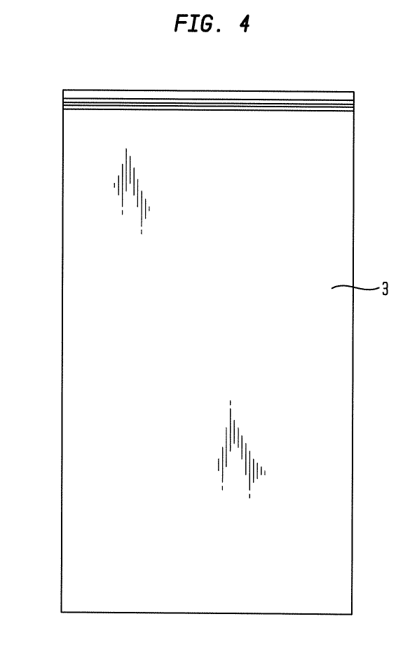

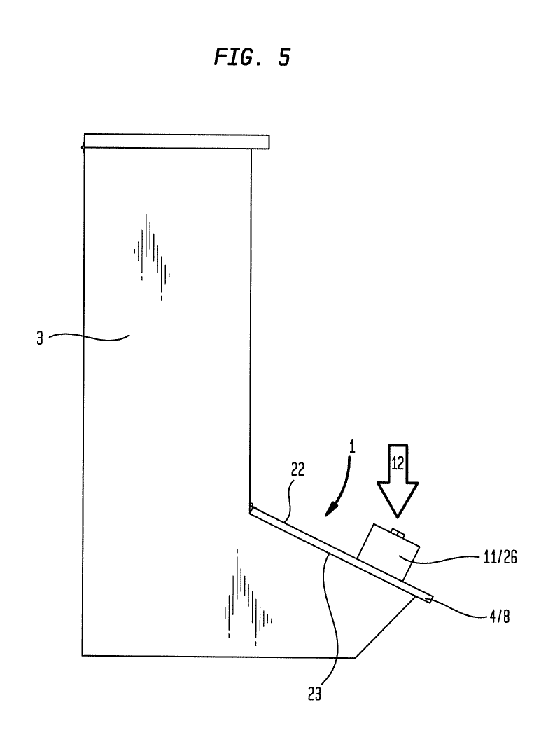

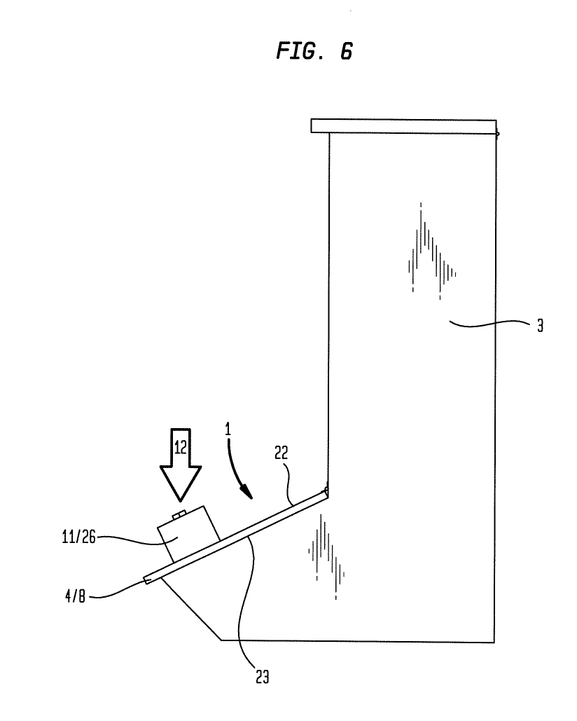

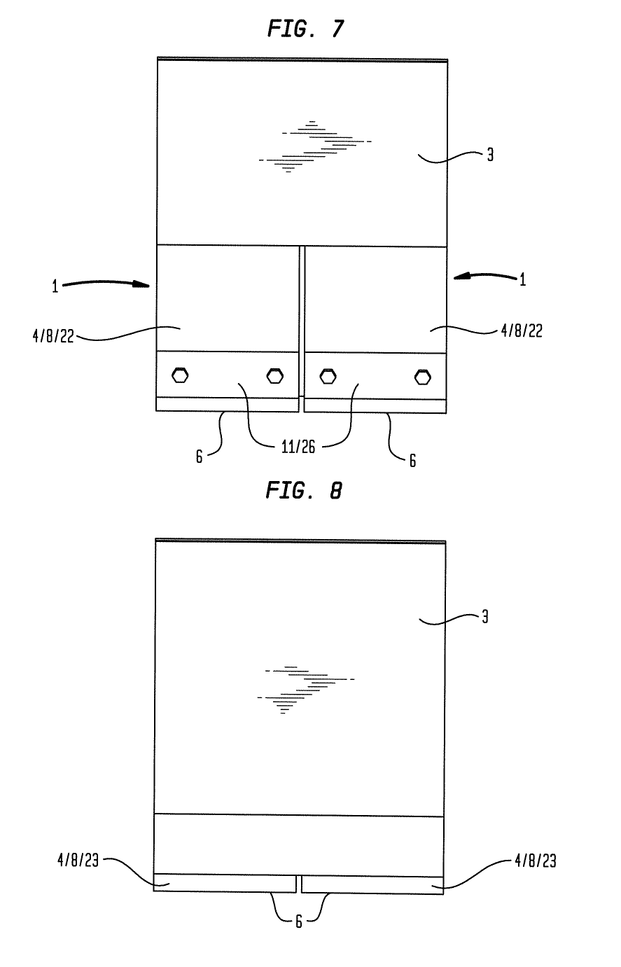

Now referring primarily to FIG. 2 through FIG. 8, the selective access system (1) includes a cover (4) having opposing cover upper and lower faces (22)(23) extending to a cover edge (24) which defines a cover periphery (25), whereby the cover (4) is configured to couple to a feeder (3) and overlay a feeder opening (10) in which ingestible matter (2) is disposed.

The cover periphery (25) can define any of a numerous and wide variety of configurations of varying dimensions, depending upon the feeder opening (10) which the cover (4) is configured to overlay. As shown in the examples of the Figures, the cover periphery (25) can be generally rectangular; however the invention need not be limited to this particular configuration.

The cover (4) further includes opposing cover first and second ends (5)(6), whereby the cover first end (5) is configured to rotatably couple to the feeder (3) to allow the cover (4) to rotate about a rotation axis (7) between a first position (8) and a second position (9). In the first position (8), the cover (4) overlays the feeder opening (10) in which the ingestible matter (2) is disposed. In the second position (9), the cover (4) disposes away from the feeder opening (10) to permit access to the ingestible matter (2).

As but one non-limiting example, the cover first end (5) can be rotatably coupled to the feeder (3) via a hinge assembly, which may include a living hinge or a pair of hinge members coupled via a pivot pin which can define the rotation axis (7).

Again referring primarily to FIG. 2 through FIG. 8, the selective access system (1) further includes a force generator (11) coupled to the cover (4).

As to particular embodiments, the force generator (11) can be coupled to the cover (4) distal from the cover first end (5).

As to particular embodiments, the force generator (11) can be coupled to the cover (4) proximate the cover second end (6).

The force generator (11) can be coupled to the cover (4) via any of a numerous and wide variety of couplers as would be known to one of ordinary skill in the art, including as illustrative examples: adherents, adhesives, and mechanical fasteners

The force generator (11) generates a pre-selected force amount (12). As relates to the present invention, selective access to the ingestible matter (2) disposed within the feeder (3) can be accomplished by pre-selecting a force amount of the force generator (11) such that only a counterforce generator (13), for example a targeted animal (15), can supply the counterforce amount (14) which is greater than the pre-selected force amount (12).

Accordingly, only the targeted animal (15) (or a comparable counterforce generator (13)) can generate a sufficient counterforce amount (14) to oppose the pre-selected force amount (12) of the force generator (11) to provide the second position (9) of the cover (4), thereby disposing the cover (4) away from the feeder opening (10) to permit access to the ingestible matter (2), for example bait (17) including a toxic agent (18).

In contrast, a non-targeted animal (19) is not able to supply a sufficient counterforce amount (14) to oppose the pre-selected force amount (12) of the force generator (11) and consequently, the non-targeted animal (19) is not able to provide the second position (9) of the cover (4). Correspondingly, the first position (8) of the cover (4) is maintained, thereby precluding the non-targeted animal (19) from accessing the ingestible matter (2), for example bait (17) including a toxic agent (18).

Again referring primarily to FIG. 2 through FIG. 8, as to particular embodiments, the force generator (11) can be configured as a weight element (26) which generates the pre-selected force amount (12), whereby the pre-selected force amount (12) corresponds to the weight of the weight element (26) or the force of gravity on the weight element (26).

As to particular embodiments, the pre-selected force amount (12) generated by the weight element (26) can be selected to require the counterforce generator (13) to comprise a specific grouping of animals, whereby an individual animal within the specific grouping could supply a counterforce amount (14) which is greater than the pre-selected force amount (12) to dispose the cover (4) in the second position (9), allowing access to the ingestible matter (2) disposed within the feeder opening (10).

As to particular embodiments, the specific grouping of animals can comprise a biological classification of animals, such as a taxonomic rank, whereby the taxonomic rank can be selected from the group including or consisting of: family, genus, and species.

As to particular embodiments, the family can be Suidae, to which pigs or swine belong.

As to particular embodiments, the genus can be Sus.

As to particular embodiments, the species can be Sus scrofa, whereby members of this species are commonly known as wild boars (16) or feral hogs (16).

As to particular embodiments whereby wild boars (16) or feral hogs (16) comprise the targeted animals (15), the pre-selected force amount (12) of the weight element (26) can be equal to or greater than about 4.5 kilograms (about 10 pounds), which can be opposed by a typical wild boar (16) or feral hog (16) to provide the second position (9) of the cover (4), thereby disposing the cover (4) away from the feeder opening (10) to permit access to the ingestible matter (2), for example bait (17) including a toxic agent (18).

Conversely, a non-targeted animal (19), which may typically be found to coexist with the wild boars (16) or feral hogs (16), would not be able to supply a sufficient counterforce amount (14) to oppose the pre-selected force amount (12) of the force generator (11). Following, the non-targeted animal (19) would not able to provide the second position (9) of the cover (4); thus, the first position (8) of the cover (4) would be maintained and the non-targeted animal (19) would be precluded from accessing the ingestible matter (2), for example bait (17) including a toxic agent (18).

As but one illustrative example, an exemplary geographical region of the United States in which the selective access system (1) may be useful for facilitating management of targeted animals (15) comprising wild boars (16) or feral hogs (16) includes Texas, which is home to an estimated 2 million wild boars (16) or feral hogs (16) (about 50% of all the wild boars (16) or feral hogs (16) in the United States). Within this region, non-targeted animals (19) which may coexist with the wild boars (16) or feral hogs (16) include livestock (20) such as cattle, goats, horses, and sheep (as non-limiting examples) and wildlife (21) such as beavers, coyotes, deer, foxes, lizards, rattlesnakes, skunks, tortoises, and turkeys (as non-limiting examples).

As a result, an embodiment of the selective access system (1) useful in this region would have a pre-selected force amount (12) of the weight element (26) such that the pre-selected force amount (12) is (a) lesser than a counterforce amount (14) which can be generated by a typical wild boar (16) or feral hog (16) and (b) greater than a counterforce amount (14) which can be generated by livestock (20) such as cattle, goats, horses, and sheep (as non-limiting examples) and wildlife (21) such as beavers, coyotes, deer, foxes, lizards, rattlesnakes, skunks, tortoises, and turkeys (as non-limiting examples). Research suggests that a weight element (26) having a pre-selected force amount (12) in a range of between about 4.5 kilograms (about 10 pounds) to about 9 kilograms (about 20 pounds) meets both criteria (a) and (b).

As to particular embodiments whereby wild boars (16) or feral hogs (16) comprise the targeted animals (15), the pre-selected force amount (12) of the weight element (26) can be in a range selected from the group including or consisting of: between about 4.5 kilograms and about 5.5 kilograms; between about 5 kilograms and about 6 kilograms; between about 5.5 kilograms and about 6.5 kilograms; between about 6 kilograms and about 7 kilograms; between about 6.5 kilograms and about 7.5 kilograms; between about 7 kilograms and about 8 kilograms; between about 7.5 kilograms and about 8.5 kilograms; between about 8 kilograms and about 9 kilograms.

As to particular embodiments whereby wild boars (16) or feral hogs (16) comprise the targeted animals (15), the pre-selected force amount (12) of the weight element (26) can be equal to or greater than a weight selected from the group including or consisting of: 4 kilograms; 4.5 kilograms; 5 kilograms; 5.5 kilograms; 6 kilograms; 6.5 kilograms; 7 kilograms; 7.5 kilograms; 8 kilograms; 8.5 kilograms; and 9 kilograms.

As to other particular embodiments, the pre-selected force amount (12) of the weight element (26) can be equal to or greater than a weight selected from the group including or consisting of: 0.1 kilograms; 0.5 kilograms; 1 kilograms; 1.5 kilograms; 2 kilograms; 2.5 kilograms; 3 kilograms; 3.5 kilograms; 4 kilograms; 4.5 kilograms; 5 kilograms; 5.5 kilograms; 6 kilograms; 6.5 kilograms; 7 kilograms; 7.5 kilograms; 8 kilograms; 8.5 kilograms; and 9 kilograms.

In addition to weight elements (26), other force generators (11) contemplated for use with the instant selective access system (1) include generators of frictional force, generators of tension force, generators of spring force, or the like.

A method of making a selective access system (1) for permitting selective access to ingestible matter (2) disposed within a feeder (3) includes coupling a force generator (11) to a cover (4) configured to overlay a feeder opening (10) of the feeder (3), whereby the force generator (11) generates a pre-selected force amount (12).

The method can, but need not necessarily, further include rotatably coupling a cover first end (5) to the feeder (3) to allow the cover (4) to rotate about a rotation axis (7) between a first position (8) and a second position (9). In the first position (8), the cover (4) overlays a feeder opening (10) in which the ingestible matter (2) is disposed. In the second position (9), the cover (4) disposes away from the feeder opening (10) to permit access to the ingestible matter (2). Further, the force generator (11) generates a pre-selected force amount (12) which when unopposed, provides the first position (8) of the cover (4).

As to particular embodiments, the second position (9) is provided by a counterforce generator (13) which generates a counterforce amount (14) which is greater than the pre-selected force amount (12).

The method can, but need not necessarily, further include coupling the force generator (11) to the cover (4) distal from the cover first end (5).

The method can, but need not necessarily, further include coupling the force generator (11) to the cover (4) proximate the cover second end (6).

The method can, but need not necessarily, further include configuring the force generator (11) as a weight element (26) which generates the pre-selected force amount (12).

The method can, but need not necessarily, further include selecting the pre-selected force amount (12) to require the counterforce generator (13) to comprise a specific grouping of animals. As to particular embodiments, the specific grouping of animals comprises a taxonomic rank. As to particular embodiments, the taxonomic rank is selected from the group including or consisting of: family, genus, and species. As to particular embodiments, the family comprises Suidae. As to particular embodiments, the genus comprises Sus. As to particular embodiments, the species comprises Sus scrofa. As to particular embodiments, the specific grouping of animals comprises wild boars (16) or feral hogs (16).

The method can, but need not necessarily, further include configuring the pre-selected force amount (12) to be equal to or greater than about 4.5 kilograms.

The method can, but need not necessarily, further include configuring the pre-selected force amount (12) to be in a range of between about 4.5 kilograms to about 9 kilograms.

The method can, but need not necessarily, further include configuring the pre-selected force amount (12) to be equal to or greater than a weight selected from the group including or consisting of: 4 kilograms; 4.5 kilograms; 5 kilograms; 5.5 kilograms; 6 kilograms; 6.5 kilograms; 7 kilograms; 7.5 kilograms; 8 kilograms; 8.5 kilograms; and 9 kilograms.

The method can, but need not necessarily, further include configuring the pre-selected force amount (12) to be equal to or greater than a weight selected from the group including or consisting of: 0.1 kilograms; 0.5 kilograms; 1 kilograms; 1.5 kilograms; 2 kilograms; 2.5 kilograms; 3 kilograms; 3.5 kilograms; 4 kilograms; 4.5 kilograms; 5 kilograms; 5.5 kilograms; 6 kilograms; 6.5 kilograms; 7 kilograms; 7.5 kilograms; 8 kilograms; 8.5 kilograms; and 9 kilograms.

As to particular embodiments, the ingestible matter (2) comprises bait (17). As to particular embodiments, the bait (17) includes a toxic agent (18).

The cover (4) of the selective access system (1) can be formed from one or more of any of a numerous and wide variety of materials capable of covering a feeder opening (10) to preclude access to ingestible matter (2) disposed within the feeder opening (10). As non-limiting examples, the cover (4) can be formed from materials such as: plastic, plastic-like material, metal, metal-based material, wood, wood-based material, paper, paper-based material, or the like, or combinations thereof.

Additionally, the cover (4) can be formed from any of a numerous and wide variety of processes depending upon the application, such as press molding, injection molding, fabrication, machining, printing, additive printing, or the like, or combinations thereof, as one piece or assembled from a plurality of pieces into an embodiment of the cover (4).

The weight element (26) of the selective access system (1) can be formed from one or more of any of a numerous and wide variety of materials capable of generating the pre-selected force amount (12) which when unopposed, provides the first position (8) of the cover (4). As but one non-limiting example, the weight element (26) can be formed from metal.

As to particular embodiments, the weight element (26) can be coupled to the cover (4), whereby each of the weight element (26) and the cover (4) are discrete elements. As to other particular embodiments, the weight element (26) and the cover (4) can be formed as a one-piece construct.

As to particular embodiments, the cover (4) including the weight element (26) can replace an existing cover (4) of a feeder (3). As to other particular embodiments, the weight element (26) can be coupled to an existing cover (4) of a feeder (3), thereby retrofitting the existing cover (4) to provide the selective access system (1).

A method of using a selective access system (1) coupled to a feeder (3) for permitting selective access to ingestible matter (2) disposed within the feeder (3) includes obtaining the selective access system (1) as described above, disposing ingestible matter (2) within a feeder opening (10) of the feeder (3); and providing the first position (8) of the cover (4). As to particular embodiments, the second position (9) is provided by a counterforce generator (13) which generates a counterforce amount (14) which is greater than the pre-selected force amount (12).

The method can, but need not necessarily, further include providing bait (17) as the ingestible matter (2). As to particular embodiments, the method can, but need not necessarily, further include combining a toxic agent (18) with the bait (17).

As to particular embodiments, the force generator (11) can comprise a weight element (26) which generates the pre-selected force amount (12).

The method can, but need not necessarily, further include selecting the pre-selected force amount (12) to require the counterforce generator (13) to comprise a specific grouping of animals.

The method can, but need not necessarily, further include selecting the pre-selected force amount (12) to require the counterforce generator (13) to comprise a taxonomic rank. As to particular embodiments, the taxonomic rank can be selected from the group including or consisting of: family, genus, and species.

The method can, but need not necessarily, further include selecting the pre-selected force amount (12) to require the counterforce generator (13) to comprise Suidae.

The method can, but need not necessarily, further include selecting the pre-selected force amount (12) to require the counterforce generator (13) to comprise Sus.

The method can, but need not necessarily, further include selecting the pre-selected force amount (12) to require the counterforce generator (13) to comprise Sus scrofa.

The method can, but need not necessarily, further include selecting the pre-selected force amount (12) to require the counterforce generator (13) to comprise wild boars (16) or feral hogs (16).

The method can, but need not necessarily, further include selecting the pre-selected force amount (12) to be equal to or greater than about 4.5 kilograms.

As can be easily understood from the foregoing, the basic concepts of the present invention may be embodied in a variety of ways. The invention involves numerous and varied embodiments of a selective access system and methods for making and using such a selective access system, including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “cover” should be understood to encompass disclosure of the act of “covering”—whether explicitly discussed or not—and, conversely, were there effectively disclosure of the act of “covering”, such a disclosure should be understood to encompass disclosure of a “cover” and even a “means for covering”. Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the selective access systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A selective access system for permitting selective access to ingestible matter disposed within a feeder, said selective access system comprising:
a cover having opposing cover first and second ends, said cover first end configured to rotatably couple to said feeder to allow said cover to rotate about a rotation axis between a first position and a second position;
wherein in said first position, said cover overlays a feeder opening in which said ingestible matter is disposed;
wherein in said second position, said cover disposes away from said feeder opening to permit access to said ingestible matter; and
a force generator coupled to said cover;
wherein said force generator generates a pre-selected force amount which when unopposed, provides said first position of said cover.

2. The selective access system of claim 1, wherein said second position is provided by a counterforce generator which generates a counterforce amount which is greater than said pre-selected force amount.

3. The selective access system of claim 1, wherein said force generator is coupled to said cover distal from said cover first end.

4. The selective access system of claim 1, wherein said force generator is coupled to said cover proximate said cover second end.

5. The selective access system of claim 2, wherein said force generator comprises a weight element which generates said pre-selected force amount.

6. The selective access system of claim 5, wherein said pre-selected force amount is selected to require said counterforce generator to comprise a specific grouping of animals.

7. The selective access system of claim 6, wherein said specific grouping of animals comprises a taxonomic rank.

8. The selective access system of claim 7, wherein said taxonomic rank is selected from the group consisting of: family, genus, and species.

9. The selective access system of claim 8, wherein said family comprises Suidae.

10. The selective access system of claim 8, wherein said genus comprises Sus.

11. The selective access system of claim 8, wherein said species comprises Sus scrofa.

12. The selective access system of claim 6, wherein said specific grouping of animals comprises wild boars or feral hogs.

13. The selective access system of claim 6, wherein said pre-selected force amount is equal to or greater than about 4.5 kilograms.

14. The selective access system of claim 6, wherein said pre-selected force amount is in a range of between about 4.5 kilograms to about 9 kilograms.

15. The selective access system of claim 6, wherein said pre-selected force amount is equal to or greater than a weight selected from the group consisting of: 4 kilograms; 4.5 kilograms; 5 kilograms; 5.5 kilograms; 6 kilograms; 6.5 kilograms; 7 kilograms; 7.5 kilograms; 8 kilograms; 8.5 kilograms; and 9 kilograms.

16. The selective access system of claim 6, wherein said pre-selected force amount is equal to or greater than a weight selected from the group consisting of: 0.1 kilograms; 0.5 kilograms; 1 kilograms; 1.5 kilograms; 2 kilograms; 2.5 kilograms; 3 kilograms; 3.5 kilograms; 4 kilograms; 4.5 kilograms; 5 kilograms; 5.5 kilograms; 6 kilograms; 6.5 kilograms; 7 kilograms; 7.5 kilograms; 8 kilograms; 8.5 kilograms; and 9 kilograms.

17. The selective access system of claim 6, wherein said ingestible matter comprises bait.

18. The selective access system of claim 17, wherein said bait includes a toxic agent.

19. A method of making a selective access system for permitting selective access to ingestible matter disposed within a feeder, said method comprising:
coupling a force generator to a cover configured to overlay a feeder opening of said feeder;
wherein said force generator generates a pre-selected force amount.

20-37. (canceled)

38. A method of using a selective access system coupled to a feeder for permitting selective access to ingestible matter disposed within said feeder, said method comprising:
obtaining said selective access system comprising:
a cover having opposing cover first and second ends, said cover first end configured to rotatably couple to said feeder to allow said cover to rotate about a rotation axis between a first position and a second position;
wherein in said first position, said cover overlays a feeder opening in which said ingestible matter is disposed;
wherein in said second position, said cover disposes away from said feeder opening to permit access to said ingestible matter; and
a force generator coupled to said cover;
wherein said force generator generates a pre-selected force amount which when unopposed, provides said first position of said cover;
disposing ingestible matter within a feeder opening of said feeder; and
providing said first position of said cover.

39-50. (canceled)
